(19) United States
(12) Patent Application Publication
(10) Pub. No.: US 2016/0270376 A1
(43) Pub. Date: Sep. 22, 2016

(54) CHICK STARTING FEED OUTLET DEVICE

(71) Applicant: CTB, Inc., Milford, IN (US)

(72) Inventors: John Cole, Milford, IN (US); Neil Cripe, New Paris, IN (US); Jim Kraft, New Paris, IN (US); Wayne Mark, Elkhart, IN (US)

(21) Appl. No.: 15/076,202

(22) Filed: Mar. 21, 2016

Related U.S. Application Data
(60) Provisional application No. 62/136,190, filed on Mar. 20, 2015.

(51) Int. Cl. A01K 39/012; A01K 39/014

(52) U.S. Cl. CPC A01K 39/0125; A01K 39/014

(57) ABSTRACT

The invention provides for a chick starter feed outlet device for use with a poultry feeder system that includes a feed tube. The device provides for the feeding of younger poultry that may not he efficiently fed by existing poultry feeders alone and is contemplated for usage in conjunction with existing poultry feeders. The chick starter feed outlet device includes two operably associated parts including a component for connecting with and receiving feed from the feed tube and a drop tube device connected with the connecting component that may be selectively operated to provide feed in feed pans below the outlet device.

### INCORPORATION BY REFERENCE AND PRIORITY CLAIM

This patent application claims the benefit of domestic priority of U.S. Provisional Patent Application Ser. No. 62/136,190, filed Mar. 20, 2015, and entitled “Chick Starting Feed Outlet Device”, U.S. Provisional Patent Application Ser. No 62/136,190 is hereby incorporated by reference in its entirety.

### FIELD OF THE INVENTION

The invention relates in general to poultry feeding systems, More specifically, the invention relates to a feed outlet device to be used in connection with delivering feed to young poultry, namely chicks,

### BACKGROUND OF THE INVENTION

Poultry feeding systems are known in the art and generally comprise a feed source, a plurality of feeders, and a feed delivery system that is designed to transport feed from the feed source to the plurality of feeders. Such feed delivery systems typically comprise elongated feeding tubes having openings at predetermined locations, which openings allow for feed moving through the tubes to move into the feeders. The feeders are of known configuration and are used to raise birds to over nine pounds. As such, they are typically designed to efficiently feed poultry up to that large size. Because of those features designed to accommodate larger poultry, they may not be ideal for starting to feed day old birds and other young birds. As it is undesirable to move poultry from one location to another as they age, it is desirable that the feeding systems also be able to be sufficiently adaptable so as to also be able to provide appropriate feed to younger birds or chicks as well.

U.S. Pat. No. 4,488,509 to Await sought to provide a solution to this problem The feeding device described and illustrated in the '509 patent (which is commercially sold under the brand name Chiekmate®), provides a device which connects to the feeding tube to allow for the device to dispense feed in a controlled manner below the feeding tube (as the devices extend perpendicularly downwardly from the feeding tube) in desired locations, typically in feed trays located between feeders used for larger/older poultry. The feed trays also give more feeder space in general as day-old and younger chicks can eat out of either the feed trays or the feeders and the extra space gives more birds access at once. When the poultry chicks grow such that they can use the desired feeders, the feed trays are typically removed and the devices are rotated upwardly (such that they extend perpendicularly upwardly from the feeding tube) such that they are removed from between adjacent feeders.

These devices, however, have some problems associated with them. First, frequently anti-roost wires are set up above the feeding tubes to prevent poultry from roosting or sitting on the feeding tubes themselves. If the devices of the '509 patent are utilized, they may not be able to be readily positioned in their desired location due to the presence of the anti-roost wires. Secondly, when the devices are in their non-use state (or closed position), feed/dust/debris can collect inside of the device which can be very undesirable for a number of reasons, one of which is that all of the feed, dust or debris will spill or fall out of the device when the device is moved back to its use state.

Another product that sought to solve these problems is the E-Z START® device commercialized by CTB, Inc., also the assignee of the present invention. The E-Z START® prior art device is pictured in FIG. 1, and is identified by reference numeral 10. Similar to the chickmate® device, the E-Z START® device 10 provides a device which connects to the feeding tube 30 to allow for the device 10 to dispense feed in a controlled manner below the feeding tube 30 (as the devices 10 extend perpendicularly downwardly from the feeding tube 30) in desired locations, typically in feed trays 14 located between feeders 18 used for larger or older poultry. When the chicks grow to a sufficiently large size such that they can use the desired feeders 18, the feed trays 14 are typically removed and the devices 10 are rotated upwardly (such that they extend approximately parallel with and underneath the feeding tube 30).

These devices 10 overcome some of the problems associated with the Chickmate® device, namely, that they do not present problems with anti-roost wires 16 and are unlikely to collect as much feed/dust/debris in them in their non-use states (or closed positions). However, these devices 10 do have the need to occupy space between adjacent feeders 18 (even more so if the device 10 has further accessories—such as a cone 15 or a telescoping piece attached thereto as may be desired) such they may be in the way of larger or older poultry accessing or otherwise feeding from the feeders.

Accordingly, there is a need for a chick starter feed outlet device that overcomes some of the shortcomings associated with the known prior art devices. The invention of the present application provides a chick starter feeder outlet device for use in delivering feed to young poultry, namely, chicks, which addresses some of the disadvantages of the prior art.

### DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a prior art chick feeder system;

FIG. 2 is a partial plan view of a feeding tube adapted for use with the chick starter feed outlet device of the present invention;

FIG. 3 is a cross-sectional view along the line 3-3 of FIG. 2;

FIG. 4 is a cross-sectional view along the line 4-4 of FIG. 2;

FIG. 5 is a perspective view of the chick starter feed outlet device of the present invention shown in an open or feeding position;

FIG. 6 is a perspective view of the chick starter feed outlet device of the present invention shown in a closed or non-feeding position;

FIGS. 7-10 are plan views of the feed connecting device component of the present invention;

FIGS, 11-13 are plan views of the drop tube component of the present invention;

FIG. 14 is a plan view of one side of a portion of the drop tube component of the present invention;

FIG. 15 is a cross-sectional view of the drop tube component of the present invention; and

FIG. 16 is a perspective view of an alternate embodiment of the present invention.

### DETAILED DESCRIPTION OF THE ILLUSTRATED EMBODIMENTS

While the invention may be susceptible to embodiment in different forms, there is shown in the drawings, and herein will be described in detail, specific preferred embodiments with the understanding that the present disclosure is to be considered exemplary of the principles of the invention, and is not intended to limit the invention to that as illustrated and described herein.

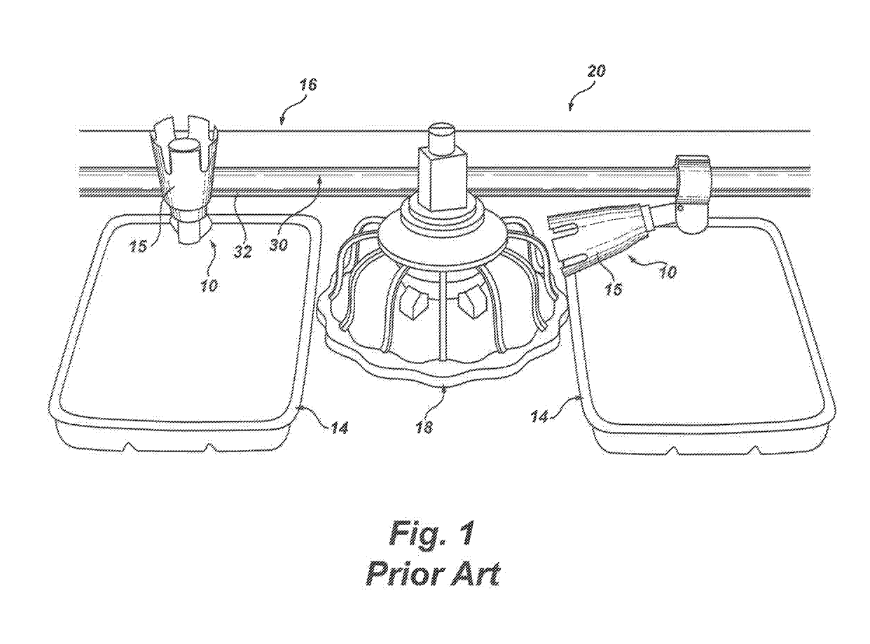

The present invention provides a novel chick starter feed outlet device 100 for use in connection with a feed line assembly 20, where the feed line assembly 20 includes an elongated feed tube 30, as best illustrated in FIGS. 1-4, As is known in the art, the feed tube 30 is preferably formed of metal and is preferably formed to have a rib 32 extending outwardly and longitudinally therefrom along its length. The rib 32 is preferably formed as a seam of the feed tube 30 upon the formation of the feed tube 30. The feed tube 30 also has a plurality of openings 34 provided at a lower end thereof, such that feed moving through the feed tube 30 can exit the feed tube 30 through one or more of the openings 34. The openings 34 are preferably circular in configuration, but may have any other configuration as desired. The feed to 30 preferably has a cylindrical configuration, except with regard to the rib 32. With the openings 34 being positioned at a lower end of the feed tube 30, the rib 32 is preferably positioned above, and offset from, the openings 34, such that in its working or feeding position, the rib 32 is typically extending outwardly and downwardly, at an angle, from the feed tube 30.

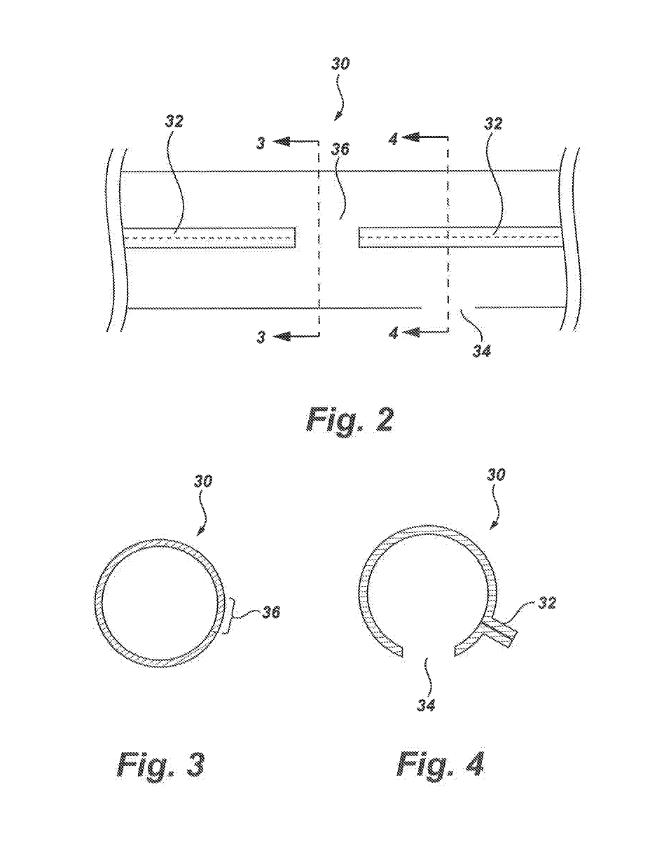

In connection with the feed outlet device 100 of the present invention, the feed tube 30 is preferably slightly modified. More specifically, and as shown in FIG. 2, portions of the rib 32 of the feed tube 30 are removed at desired positions along the length of the feed tube, preferably adjacent to where the openings 34 are provided, such that the feed tube 30 is provided with one or more notches 36 along the length thereof.

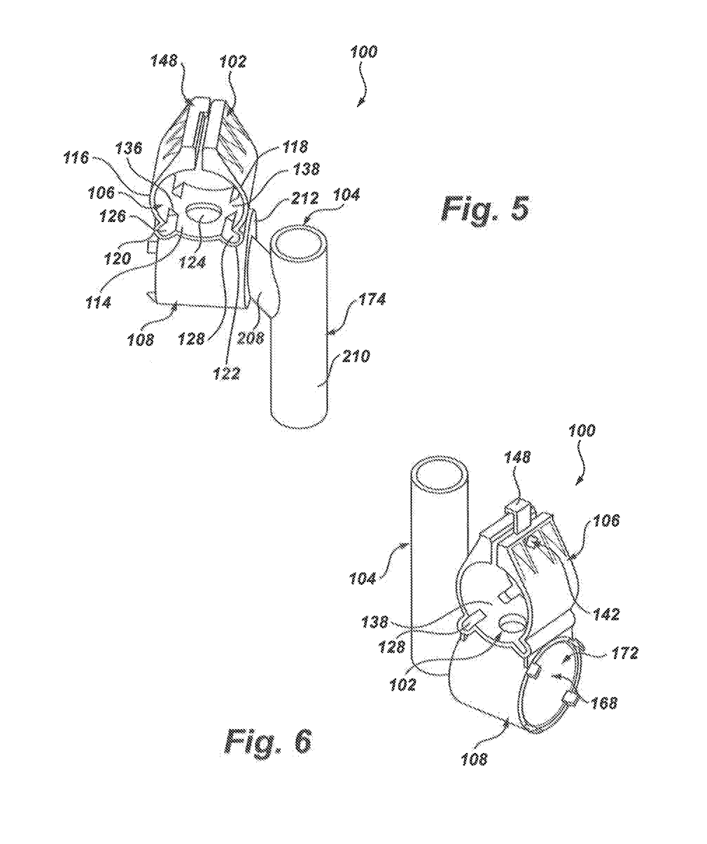

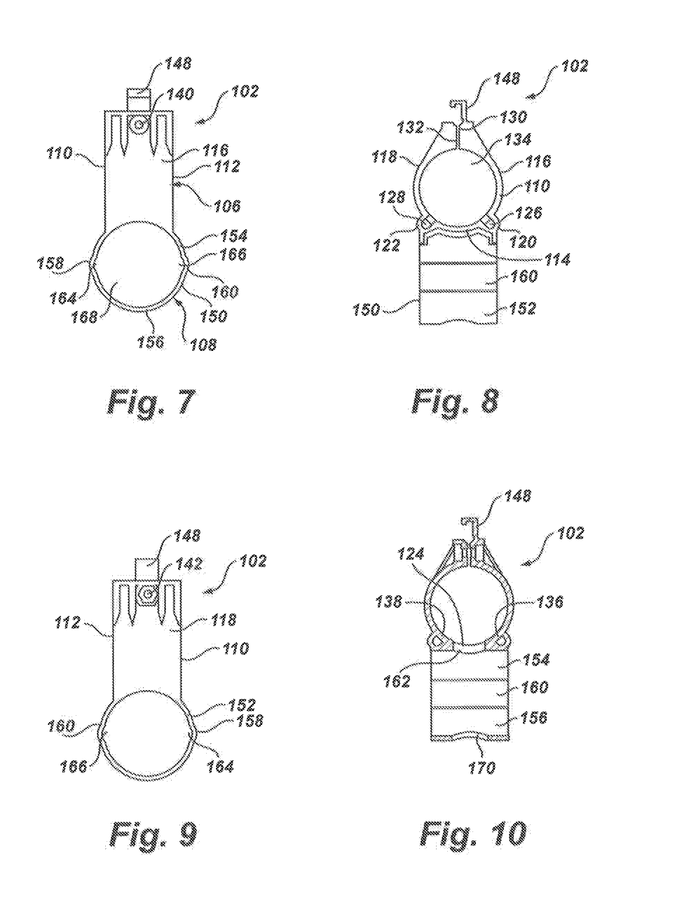

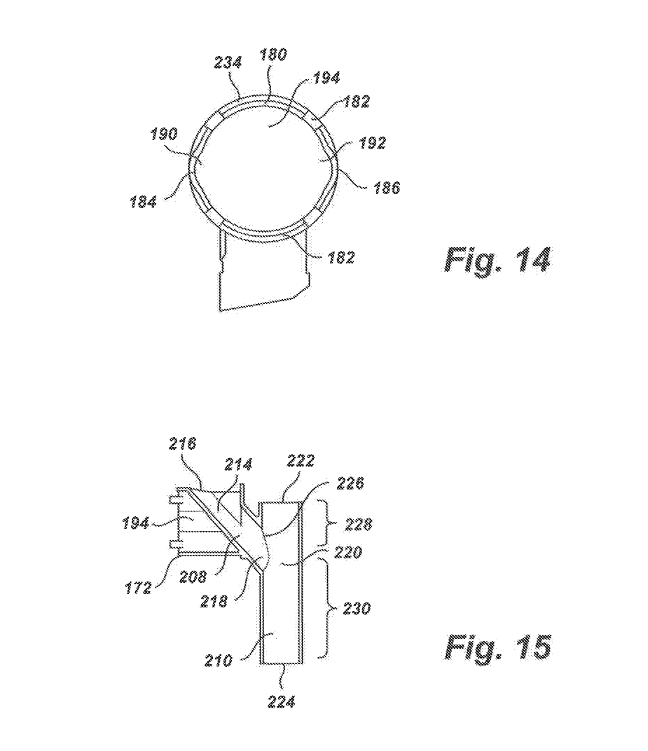

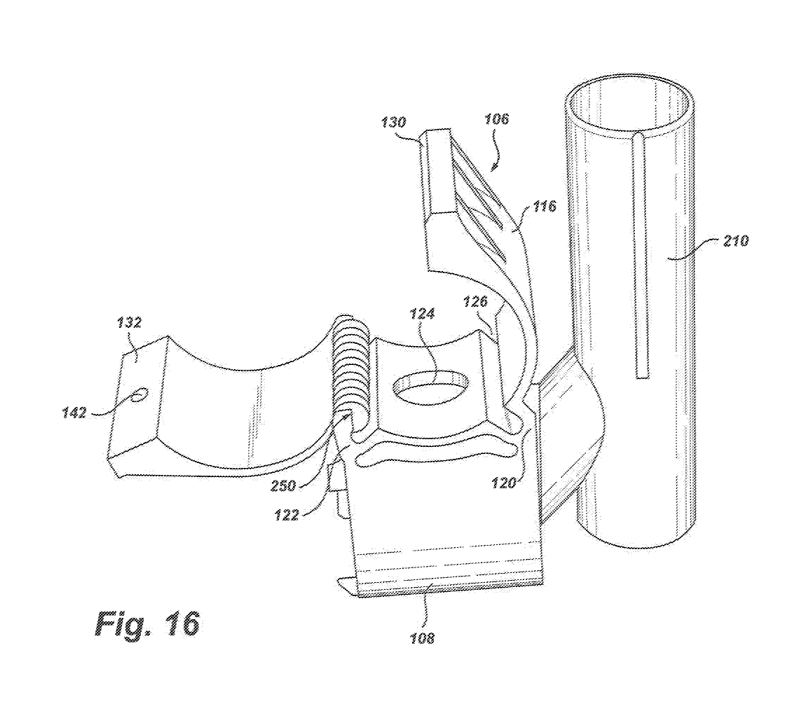

As best illustrated in FIGS. 5-15, the feed outlet device 100 is preferably formed of two operably associated parts, namely, a feed tube connecting device 102 and a drop tube device 104, where the position of the drop tube device 104 is preferably adjustable relative to the position of the feed tube connecting device 102, as will be discussed in further detail. hereinbelow.

As best illustrated in FIGS. 5-10, the feed tube connecting device 102 has a feed tube receiving portion 106 and a drop tube receiving portion 108, The feed tube receiving portion 106 and the drop tube receiving portion 108 are preferably secured to one another and/or are integrally formed, with the drop tube receiving portion 108 being positioned generally below the feed tube receiving portion 106.

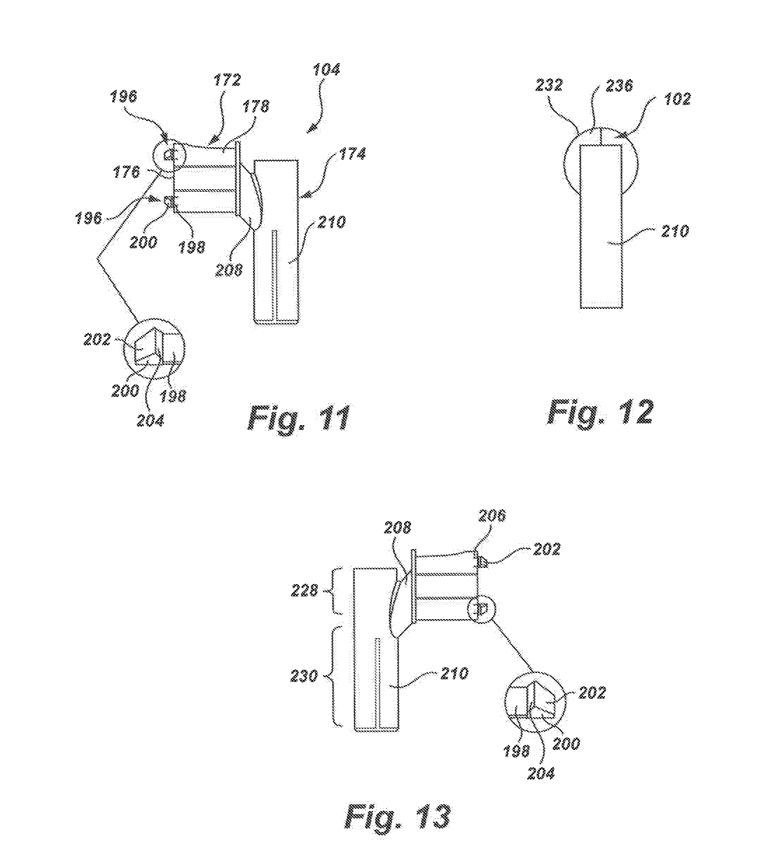

The feed tube receiving portion 106 is substantially cylindrical in cross section. and has a first end 110 and a second, opposite end 112 and is formed of a base portion 114, first and second arm portions 116, 118, and first and second slotted portions 120, 122 as best seen in FIGS. 5 and 10. The base portion 114 has an opening 124 provided therethrough, preferably generally equidistantly between the first and second ends 110, 112. The opening 124 is preferably generally circular in configuration, but may have any other configuration as desired. Preferably, the configuration of the opening 124 matches the configuration of the opening 34 provided through the feed tube 30. Of course, it is to be understood that, if desired, the opening 124 could be comprised of multiple openings, so long as the opening 124, whether singular or multiple, allows for the flow of feed therethrough, as will be discussed in further detail hereinbelow.

The first and second slotted portions 120, 122 connect the first and second arm portions 116, 118, respectively, to the base portion 114. The portions 1.14, 116, 118, 120, 122 are preferably secured to one another and/or are integrally formed. The first and second slotted portions 120 are generally U-shaped in configuration and extend from the first end 110 to the second end 112, such that they each define a slot 126, 128, respectively.

The first and second arm portions 116, 118 extend upwardly from the first and second slotted portions 120, 122, respectively, to free ends 130, 132. The free ends 130, 132 of the first and second arm portions 116, 118 are positioned to face one another while the first and second arm portions 116, 118 are in a normal position. With the free ends 130, 132 facing one another, the base portion 114 and the first and second arm portions 116, 118 generally have a circular cross-section and form a cylindrical opening 134 through the feed tube receiving portion 106, which extends from the first end 110 to the second end 112 as shown in FIG. 8. The first and second arm portions 116, 118 are preferably formed of a material which allows them to flex outwardly, such that the free ends 130, 132 may be selectively moved away from each other.

Rib portions 136, 138 are positioned in each of the slots 126, 128, respectively, preferably generally equidistantly between the first and second ends 110, 112. The rib portions 136, 138 are sized to be positioned within the notches 36 of the rib 32 of the feed tube 30, as will be discussed in further detail hereinbelow, The rib portion 136 may be secured to and/or integrally formed with one or more of the base portion 114, the first arm portion 116 and the first slotted portion 120. Likewise, the rib portion 138 may be secured to and/or integrally formed with one or more of the base portion 114, the second arm portion 118 and the second slotted portion 122.

Each of the upper portions of the first and second arm portions 116, 118 preferably have an aperture 140, 142 provided therethrough, respectively. The apertures 140, 142 are preferably positioned to be in alignment with one another when the first and second arm portions 116, 118 are in their normal (closed) positions, such that a fastener (not shown), such as a screw, can extend therethrough, and such that a securement device (not shown), such as a nut, can secure the fastener in place, thus securing the first and second arm portions 116, 118 in place relative to one another.

One of the first and second arm portions 116, 118 preferably has a living hinge clasp 148 extending therefrom which can, either separately from the fastener and securement device, or in addition thereto, be manipulated to secure the first and second arm portions 116, 118 in place relative to one another.

The drop tube receiving portion 108 has a first end 150 and a second, opposite end 152 and is formed of an upper portion 154, a lower portion 156, and first and second slotted portions 158, 160, The upper portion 154 has an opening 162 provided therethrough, preferably generally equidistantly between the first and second ends 150, 152, The opening 162 is generally circular in configuration, but may have any other configuration as desired. Preferably, as shown in FIG. 10, the configuration of the opening 162 matches the configuration of the opening 124 provided through the base portion 114 of the feed tube receiving portion 106. Of course, it is to be understood that, if desired, the opening 162 could be comprised of multiple openings, so long as the opening 162, whether singular or multiple, allows for the flow of feed therethrough, as will be discussed in further detail hereinbelow. In a preferred embodiment, the openings 124, 162 are contiguous as the base portion 114 and the upper portion 154 are preferably integrally formed.

The first and second slotted portions 158, 160 connect the lower portion 156 to the upper portion 154. The portions 154, 156, 158, 160 are preferably secured to one another and/or are integrally formed. The first and second slotted portions 158, 160 are generally arcuate in configuration and extend from the first end 150 to the second end 152, such that they each define a slot 164, 166, respectively.

The lower portion 156 extends downwardly from the first slotted portion 158 and then upwardly to the second slotted portion 160. The upper portion 154 and the lower portion 156 generally have a circular cross-section and form a generally cylindrical opening 168 through the drop tube receiving portion 108, which extends from the first end 150 to the second end 152. The cylindrical opening 168 of the drop tube receiving portion 108 is provided in a generally transverse direction as compared to the cylindrical opening 134 of the feed tube receiving portion 106. If desired, the lower portion 156 may also have an opening 170 provided therethrough, preferably generally equidistantly between the first and second ends 150, 152. The opening 170 is generally circular in configuration, but may have any other configuration as desired.

As best illustrated in FIGS. 11-15, the drop tube device 104 has a connecting portion 172 and a drop tube portion 174. The connecting portion 172 and the drop tube portion 174 are secured to one another and/or are integrally formed.

The connecting portion 172 has a first end 176 and a second, opposite end 178 and is formed of an upper portion 180, a lower portion 182, and first and second slotted portions 184, 186, The upper portion 180 has an opening 188 provided therethrough, which preferably is positioned distal from the first end 176, but which extends to the second end 178. The opening 188 is generally rectangular in configuration at the second end 178, but is preferably circular, arcuate and/or cone shaped at its end proximate the first end 176. Of course, it is to be understood that, if desired, the opening 188 could he comprised of multiple openings, so long as the opening 188, whether singular or multiple, allows for the flow of feed therethrough, as will be discussed in further detail hereinbelow.

The first and second slotted portions 184, 186 connect the lower portion 182 to the upper portion 180. The portions 180, 182, 184, 186 are preferably secured to one another and/or are integrally formed. The first and second slotted portions 184, 186 are generally arcuate in configuration and extend from the first end 176 to the second end 178, such that they each define a slot 190, 192, respectively.

The lower portion 182 extends downwardly from the first slotted portion 184 and then upwardly to the second slotted portion 186. The upper portion 180 and the lower portion 182 generally have a circular cross-section and form a cylindrical opening 194 through the connecting portion 172, which extends from the first end 176 to the second end 178.

The first end 176 of the connecting portion 172 preferably includes a plurality of tab portions 196 extending outwardly therefrom. Each tab portion 196 is preferably capable of being flexed inwardly/outwardly as desired. Each tab portion 196 has an extending portion 198 which extends outwardly from the first end 176, and a triangular portion 200 extending outwardly therefrom which defines an angled surface 202 and a shoulder 204. The shoulder 204 is preferably parallel to, but slightly spaced apart from the first end 176. As shown in FIG. 13, notches 206 are provided in the connecting portion 172 in order to increase the effective length of the extending portions 198, and to assist in allowing the tab portion 196 to be flexed as desired. Four tab portions 196 are preferably provided, which are equidistantly spaced about the first end 176. Preferably two tab portions 196 extend from the upper portion 180 and the other two tab portions 176 extend from the lower portion 182, Thus, the tab portions 196 hold the drop tube device 104 in place. It should be noted that other configurations other than that of the tab portions 196 could be utilized, so long as the parts operate to hold the connecting portion 172 inside of the cylindrical opening 168, and allow rotation.

The drop tube portion 174 of the drop tube device 104 has first and second drop tithes 208, 210 and a flange 212 as shown in FIGS. 5 and 12. The first drop tube 208 is an angled drop tube having a generally cylindrical opening 214 which extends therethrough from a first end 216 of the first drop tube 208 to a second end 218 of the first drop tube 208. The second drop tube 210 is a vertical drop tube having a cylindrical opening 220 which extends entirely therethrough from a first end 222 of the second drop tube 210 to a second end 224 of the second drop tube 210. The first end 216 of the first drop tube 208 is positioned such that the cylindrical opening 214 of the first drop tube 208 is positioned directly below the opening 188 of the upper portion 180 of the connecting portion 172 of the drop tube device 104. In a preferred embodiment, the openings 188, 214 are contiguous as the upper portion 180 and the first drop tube 208 are preferably integrally formed, The first drop tube 208 extends through the cylindrical opening 194 of the connecting portion 172 and beyond the second end 178 of the connecting portion 172 to the second end 218 thereof.

The second end 218 of the first drop tube 208 is connected to the second drop tube 210, preferably proximate to the first end 222 of the second drop tube 210 and distal to the second end 224 of the second drop tube 210. The second drop tube 210 has an opening 226 provided therethrough where the second end 218 of the first drop tube 208 is connected. In a preferred embodiment, the openings 214, 226 are contiguous as the first and second drop tubes 208, 210 are preferably integrally formed. The opening 226 thus connects the cylindrical opening 214 of the first drop tube 208 to the cylindrical opening 220 of the second drop tube 210.

The connection of the first drop tube 208 to the second drop tube 210 provides for the second drop tube 210 to have a short drop tube section 228 and a long drop tube section 230. The short drop tube section 228 essentially extends from the first drop tube 208 to the first end 222 of the second drop tube 210, while the long drop tube section 230 essentially extends from the first drop tube 208 to the second end 224 of the second drop tube 210. The long drop tube section 230 may be provided with ribs or other features to allow for connection of accessory devices, as desired, to the second drop tube 210.

The flange 212 of the drop tube portion 174 extends outwardly from the first drop tube 208 and has an outer edge 232 that is generally circular and inner and outer generally circular surfaces 234, 236, The inner generally circular surface 234 is configured to be positioned against the second end 178 of the connecting portion 172 in order to, in general, close off the cylindrical opening 194 of the connecting portion 172 at the second end 178 thereof.

Assembly of the feed tube connecting device 102 and the drop tube device 104 to form the feed outlet device 100, as well as the connection of the feed outlet device 100 to the elongated feed tube 30 will now be discussed.

In order to form the feed outlet device 100, the drop tube device 104 must be operatively connected to the feed tube connecting device 102. The tab portions 196 of the connecting portion 172 of the drop tube device 104 are positioned next to the cylindrical opening 168 of the drop tube receiving portion 108 of the feed tube connecting device 102. The first and second slotted portions 184, 186 of the connecting portion 172 are each positioned to be in alignment with one of the slots 164, 166 defined by the first and second slotted portions 158, 160 of the drop tube receiving portion 108. In this instance, it does not matter whether the short drop tube section 228 is positioned above or below the long drop tube section 230.

The tab portions 196 are then inserted into the cylindrical opening 168 of the drop tube receiving portion 108, with the angled surfaces 202 of the triangular portions 202 of the tab portions 196 assisting in guiding the connecting portion 172 into the drop tube receiving portion 108. The tab portions 196 further are flexible due to the provision of the notches 206, thus further aiding in the insertion. The slotted portions 184, 186 are thus positioned in the slots 164, 166 of the slotted portions 158, 160. Insertion is continued until the tab portions 196 are moved through the cylindrical opening 168 such that the tab portions 196 flex back outwardly and the shoulders 204 of the tab portions 196 prevent rearward movement of the connecting portion 172. Likewise, the flange 212 abuts against the other end of the drop tube receiving portion 108. Thus, the connecting portion 172 of the drop tube device 104 is essentially held in place and operatively connected to the drop tube receiving portion 108 of the feed tube connecting device 102. With the two connected together, the feeder tube receiving portion 106, the drop tube receiving portion 108 and the connecting portion 172 are all in general vertical alignment with one another, but the second drop tube 210 of the drop tube portion 174 is generally vertically offset from them for reasons which will be discussed in further detail herein.

The feed tube connecting device 102 must also be connected to the elongated feed tube 30. In order to make this connection, the feed tube receiving portion 106 is positioned below the elongated feed tube 30. The first and second arm portions 116, 118 of the feed tube receiving portion 106 are preferably flexed apart from one another and the feed tube receiving portion 106 is moved upwardly to the elongated feed tube 30. As the feed tube receiving portion 106 is moved upwardly, the rib 32 of the elongated feed tube 30 will be positioned within one of the slots 126, 128, and one of the rib portions 136, 138 will be positioned within one of the notches 36 of the rib 32. This positioning of the parts aids in preventing the feed outlet device 100 from moving laterally along the elongated feed tube 30, and further aids in properly aligning the opening 124 of the feed outlet device 100 with the opening 34 provided through the elongated feed tube 30.

With the feed outlet device 100 properly positioned on the elongated feed tube 30, the first and second arm portions 116, 118 are flexed back toward one another (namely to their normal states) such that the free ends 130, 132 face one another. In the preferred embodiment, the living hinge clasp 148 provided on one of the first and second arm portions 116, 118 will then be flexed downwardly toward the other of the first and second arm portions 116, 118 and will clasp the other of the first and second arm portions 116, 118, thus securing the first and second arm portions 116, 118 together, If desired, the fastener and securement device can be used to secure the first and second arm portions 116, 118 together, either in conjunction with the living hinge clasp 148, or instead of the living hinge clasp 148—the latter being especially advantageous in the event that the living hinge clasp 148 is broken or not operating correctly.

Discussion of the operation of the feed outlet device 100 will now be discussed. When baby poultry chicks are introduced into a poultry house, the grower can either install the feed outlet devices 100 as described above, or the grower can manipulate previously installed feed outlet devices 100 into the appropriate position to provide feed to the poultry chicks, If installing the feed outlet devices 100, the grower should in tall them such that the long drop tube section 230 is positioned below the short drop tube section 228, as this is the desired use position the open position).

If the feed outlet devices 100 are already installed, but are in the position where the long drop tube section 230 is positioned above the short drop tube section 228 (the non-use position or the closed position), the grower will need to manipulate the drop tube device 104 relative to the feed tube connecting device 102, in order to position the long drop tube section 230 below the short drop tube section 228. The grower can manipulate the drop tube device 104 by rotating the drop tube device 104 180 degrees relative to the feed tube connecting device 102. When the drop tube device 104 is rotated 180 degrees, the long drop tube section 230 will then be positioned below the short drop tube section 228, Absent an exertion of force, rotation of the drop tube device 104 relative to the feed tube connecting device 102 is not possible as the first and second slotted portions 184, 186 of the connecting portion 172 of the drop tube device 104 are positioned within the slots 164, 166 of the drop tube receiving portion 108 of the feed tube connecting device 102. Upon a predetermined force being exerted, however, the first and second slotted portions 184, 186 will move out of the slots 164, 166, thereby allowing rotation, until the first and second slotted portions 184, 186 are moved into the other one of the slots 164, 166. Such required three is one that a grower would most likely easily be able to provide, but one that poultry would not likely be able to provide.

When the long drop tube section 230 is positioned below the short drop tube section 228, feed from the elongated feed tube 30 will flow out of, or drop from, the elongated feed tube 30 through the opening 34 and into the first drop tube 208 of the drop tube portion 174 of the drop tube device 104 via the openings 124, 162, 170, 188. Feed will enter the first drop tube 208 and will then flow angularly downwardly and outwardly within the first drop tube 208 to the second drop tube 210. The feed will then flow/drop straight downwardly through the second drop tube 210, out the second end 224 and onto the desired location, for instance a feed pan 14.

When the poultry chicks are old enough to begin using the more typical feeders 18, the feed trays 14, if any should be removed and the feed outlet device 100 should be positioned such that feed does not flow out of it (namely to the closed position). In order to position the feed outlet device 100 as such, the long drop tube section 230 needs to be positioned above the short drop tube section 228, In order to make this happen, the grower will need to manipulate the drop tube device 104 relative to the feed tube connecting device 102. The grower can manipulate the drop tube device 104 by rotating the drop tube device 104 approximately, but preferably, 180 degrees relative to the feed tube connecting device 102. When the drop tube device 104 is rotated 180 degrees, the long drop tube section 230 will then he positioned above the short drop tube section 228. Absent an exertion of force, rotation of the drop tube device 104 relative to the feed tube connecting device 102 is not possible as the first and second slotted portions 184, 186 of the connecting portion 172 of the drop tube device 104 are positioned within the slots 164, 166 of the drop tube receiving portion 108 of the feed tube connecting device 102. Upon a predetermined force being exerted, however, the first and second slotted portions 184, 186 will move out of the slots 164, 166, thereby allowing rotation, until the first and second slotted portions 184, 186 are moved into the other one of the slots 164, 166. Such required force is one that a grower would most likely easily be able to provide, but one that poultry would not likely be able to provide.

When the long drop tube section 230 is positioned above the short drop tube section 228, feed from the elongated feed tube 30 is prevented from flowing out of, or dropping from, the elongated feed tube 30 as the lower portion 182 of the connecting portion 172 of the drop tube device 104 closes off or blocks the openings 34, 124, 162.

In this position, feed/dust/debris also does not build up in the drop tube device 104, While feed/dust/debris is allowed to enter the drop tube device 104 through the long drop tube section 230, that feed/dust/debris will just flow through the drop tube device 104 and exit the drop tube device 104 through either the short drop tube section 228 or through the angled first drop tube 208 (as the angled first drop tube 208 terminates at the opening 170 of the lower portion 156 of the drop tube receiving portion 108).

Also in this position, the drop tube device 104 is offset from the elongated feed tube 30, but is also positioned generally perpendicular to the elongated feed tube 30. As such, the drop tube device 104 (and any accessories that may be connected thereto, e.g., FIG. 1 illustrates a cone member 15 connected to the drop tube device) does not get in the way between adjacent feeders 18 when the feed outlet device 100 is not in use (see, e.g., FIG. 1).

Based on the construction, attachment and operation of the feed outlet device 100, it is apparent that the feed outlet device 100 provides a number of advantages as compared to prior art devices as it overcomes the disadvantages associated with those prior art devices. More specifically, the feed outlet device 100: allows for the feed tube to be rotated beside the elongated feeding tube; provides generally “oval” rotating parts which provide two natural home states that are 180 degrees apart from one another, with one natural home state defining an open position and the other natural home state defining a closed position (it is noted that while this is the preferred embodiment, any suitable manner for locking the tube in the up position such that birds cannot move it, but humans can, could be utilized and is intended to be within the scope of the invention); the notching in the rib of the elongated feed tube and the molding of a rib portion in the feed outlet device allows for positive location of the outlet to the feed tube hole and prevents the feed outlet device from navigating away from the hole; the design allows for assembly/attachment of the feed outlet device on the feed tube without the use of any fasteners; the feed outlet device is designed to prevent feed and debris from collecting while it is in the “closed” position; the feed outlet device can be mounted with the drop tube on either side of the feed tube; the feed outlet device provides a manufacturing cost savings as it only requires two pieces; installation of the feed outlet device is simple and can be performed without any extra tools; the feed outlet device provides an ease of operation in the opening and closing; feed flow is positively stopped when in the closed position, with little chance of accidental opening, and the feed outlet rotates out of the feeding area when not in use, thus increasing the area open to larger poultry around the feeders.

In an alternate embodiment, and as illustrated in FIG, 16, instead of the arm portion 118 being integrally formed with the slotted portion 122, the two could instead be connected by a hinge assembly 250. In this scenario, the rib 32 of the elongated feed tube 30 would only likely be able to be positioned in the slots 126, thus removing some of the flexibility as to which side of the elongated feed tube 30 the second drop tube 210 would be placed.

While preferred embodiments of the present invention are shown and described, it is envisioned that those skilled in the art may devise various modifications of the present invention without departing from the spirit and scope of the invention.

The invention is claimed as follows:

1. A chick starter feed outlet device for a poultry feeding system comprising:
a feed tube connecting component adapted to be releasably installed about a portion of a feed tube of said poultry feeding system, said feed tube connecting component further comprising a feed tube receiving portion and a drop tube receiving portion; and
b) a drop tube connecting component at least partially rotatably connected with said feed tube connecting component, said drop tube connecting component further comprising a connecting portion adapted to be received at least partially within said feed tube connecting component, said drop tube connecting component further comprising a drop tube portion.
